(19) United States
(12) Patent Application Publication
(10) Pub. No.: US 2008/0193354 A1
(43) Pub. Date: Aug. 14, 2008

(54) Preparation of manganese oxide-cerium oxide-supported nano-gold catalyst and the application thereof

(75) Inventors: Yu-Wen Chen, Jhongli City (TW); Min-Hsien Lin, Taipei (TW); Hung-Chi Hsu, Taipei (TW); Jia-Hong Lin, Taipei (TW)

Correspondence Address: BACON & THOMAS, PLLC, 625 SLATERS LANE, FOURTH FLOOR, ALEXANDRIA, VA, 22314, US

(73) Assignee: Tatung Company, Taipei (TW)

(21) Appl. No.: 11/979,396

(22) Filed: Nov. 2, 2007

(30) Foreign Application Priority Data
Feb. 8, 2007 (TW) 096104656

(51) Int. Cl. B01D 53/62; B01J 23/10

(52) U.S. Cl. 423/247; 502/304

(57) ABSTRACT

This present invention provides the preparation of a manganese oxide-cerium oxide-supported nano-gold catalyst and a process for subjecting carbon monoxide and oxygen to interaction resulting in the formation of carbon dioxide in a hydrogen-rich environment by a manganese oxide-cerium oxide-supported nano-gold catalyst to remove carbon monoxide in hydrogen stream. The size of the nano-gold particle is less than 5 nm and supported on mixed oxides MnO₂/CeO₂ in various molar ratios. Preferential oxidation of CO in the presence of CO, O₂ and H₂ by the manganese oxide-cerium oxide-supported nano-gold catalyst is carried out in a fixed-bed reactor in the process of the present invention. The CO/O₂ molar ratio is in the range of 0.5 to 3. The manganese oxide-cerium oxide-supported nano-gold catalyst of the present invention is applied to reduce CO concentration in hydrogen steam to less than 100 ppm to prevent CO from contaminating the electrodes of a fuel cell.

### BACKGROUND OF THE INVENTION

1. Field of the Invention

The present invention relates to a method for preparation of a manganese oxide-cerium oxide-supported nano-gold catalyst, and a process for subjecting carbon monoxide and oxygen to interaction resulting in the formation of carbon dioxide in a hydrogen-rich environment by a manganese oxide-cerium oxide-supported nano-gold catalyst to remove carbon monoxide in a hydrogen environment. The process can be employed to reduce CO concentration in hydrogen steam in a fuel cell to less than 100 ppm to prevent CO from contaminating the electrodes of a fuel cell. The present invention also can be applied to remove CO in a hydrogen tank to enhance the purity of hydrogen steam.

2. Description of Related Art

Currently, development of a new energy source and efficient utilization of stored energy are the important issues for society and industry. A fuel cell meets the aforementioned requirements, resulting from its ability of effectively converting chemical energy to electric energy and conveniently storing energy. Fuel cells can be roughly classified into a high temperature fuel cell (its operating temperature is higher than 250° C.) and a low temperature fuel cell (its operating temperature is lower than 250° C. ), according to operating temperature. However, in consideration of safety and size, a low temperature fuel cell is more popular. In fuel cells, carbon monoxide may seriously contaminate electrodes, for example, the carbon monoxide tolerance of a phosphoric acid fuel cell (PAFC) is 2% and that of a proton exchange membrane fuel cell (PEM) is several ppm. Thereby, it is the most important issue for a fuel cell to obtain pure hydrogen gas (H₂).

H₂ gas used for a fuel cell can be obtained by various methods among which steam reforming reaction between methane and water vapor is the most economical. However, the drawback of the steam reforming reaction is the requirement for a series of purification steps on H₂ steam. In addition, the cracking reaction of a hydrocarbon compound or ammonia without the production of COx byproducts also can be performed to provide H₂ gas. During the steam reforming reaction, the reformation between methane and water vapor must induce the production of carbon monoxide byproduct which is the major factor in reducing electrode efficiency. Thereby, before the introduction of H₂ gas to a PEM fuel cell, a series of reaction steps for removing carbon monoxide is required. In a series of reaction steps, the water-gas shift (WGS) reaction between high-temperature water vapor and carbon monoxide is preformed at a temperature in the range of 350° C. to 550° C. first, where the presence of mixed catalysts Fe₂O₃/Cr₂O₃ can reduce the concentration of carbon monoxide to 3%; subsequently, the low-temperature WGS reaction is employed at a temperature in the range of 200° C. to 300° C. in the presence of Cu₂O/ZnO/Al₂O₃ catalysts to further reduce the concentration of carbon monoxide to 0.5%; and finally, the preferential oxidation (PROX) is performed to reduce the concentration of carbon monoxide to several ppm.

The preferential oxidation of carbon monoxide is one of the most efficient methods for removing carbon monoxide at present. The catalyst earlier used for the preferential oxidation commonly exhibits high ability of oxidizing carbon monoxide and H₂ gas, and the popular one is a platinum catalyst. Although the reactivity of a platinum catalyst is high, the amount of oxidized H₂ gas also increases. Thereby, the increase of the temperature causes the decrease of CO conversion ratio, resulting in the decrease of selection ratio. In addition, the CO conversion ratio in the application of Ru, Rh, Pd, and other metal catalysts on the reaction decreases with the increase of temperature, as a platinum catalyst. A comparison among the CO conversion ratios of various catalysts is shown as follows: Ru—Al₂O₃>Rh—Al₂O₃>Pt—Al₂O₃>Pd—Al₂O₃ (0.5% of metal content). Furthermore, research has pointed out that a gold catalyst is suitable for 100 ° C. reaction, a copper catalyst is suitable for 100˜200° C. reaction and a platinum catalyst can exhibit 100% CO conversion ratio in 200° C. reaction. At the same time, it was found that the presence of carbon dioxide causes the decrease of CO conversion ratio, especially for a gold catalyst. In comparison with a platinum catalyst, not only does a gold catalyst exhibit high reactivity at a temperature lower than 100° C., but also the cost of gold is much lower and more stable than platinum. The operating temperature of a gold catalyst is also suitable for a low temperature fuel cell without further raising the temperature.

The prior patents related to a gold catalyst mostly teach the application on carbon monoxide oxidization rather than preferential oxidation of carbon monoxide in H₂ stream, and do not use mixed oxides MnO₂/Fe₂O₃ as a carrier for the reaction at a temperature lower than 100° C. Among the published patents, none of them uses a manganese oxide-cerium oxide-supported nano-gold catalyst for the preferential oxidation of carbon monoxide.

In some patents, the catalysts applied in the preferential oxidation of carbon monoxide mostly are alloys of Pt, Ru, Rh, and the like. In comparison with the abroad patents, the present invention is advantageous in the comparatively low cost of gold and the high reactivity at an operating temperature lower than 100° C. The related patents are introduced as follow. U.S. Pat. No. 6,787,118 (Sep. 7, 2004) discloses a method for selectively removing carbon monoxide from a hydrogen-containing gas, where the catalyst is Pt, Pd, or Au held on a carrier of mixed oxides (Ce and other metals, such as Zr, Fe, Mn, Cu, and so on) prepared by codeposition. U.S. Pat. No. 6,780,386 (Aug. 24, 2004) discloses a carbon monoxide oxidation catalyst and a method for production of hydrogen-containing gas, where ruthenium held on a carrier of titania and alumina functions as a catalyst to reduce the concentration of carbon monoxide in hydrogen-rich gas from 0.6% to about 20 ppm. U.S. Pat. No. 6,673,742 (Jan. 6, 2004) and U.S. Pat. No. 6,409,939 (Jan. 25, 2002) disclose a preferential oxidation catalyst and a method for producing a hydrogen-rich fuel stream, where the provided Ru/Al₂O₃ catalyst (0.5˜3%) can be employed in the preferential oxidation of carbon monoxide in a hydrogen-rich fuel stream to produce a treated fuel gas stream comprising less than about 50 ppm carbon monoxide. U.S. Pat. No. 6,559,094 (May 6, 2003) discloses a method for preparation of catalytic material for selective oxidation of carbon monoxide, where the typically used catalyst is 5% Pt-0.3% Fe/Al₂O₃. U.S. Pat. No. 6,531,106 (Mar. 11, 2003) discloses a method for selectively removing carbon monoxide, where Pt, Pd, Ru, Rh, Ir, or another precious metal is supported on a crystalline silicate to function as a catalyst, and in the examples, the concentration of CO in the hydrogen gas, consisting of 0.6% CO, 24% CO₂, 20% H₂O, 0.6% O₂, and 54.8% H₂, can be reduced to 50 ppm at various temperatures. JP2003-104703 (Mar. 9, 2003) discloses a method for reducing the concentration of carbon monoxide and a fuel cell system, where an Ru—Pt/Al₂O₃ catalyst prepared in the example can be employed to reduce the concentration of CO in the hydrogen-containing gas from 6000 ppm to 4 ppm. U.S. Pat. No. 6,287,529 (Sep. 11, 2001) discloses a method and an apparatus for selective catalytic oxidation of carbon monoxide, where the apparatus is a multistage CO-oxidation reactor in which Pt or Ru held on a carrier of Al₂O₃ or a zeolite functions as a catalyst to reduce the concentration of carbon monoxide in the hydrogen-rich stream to 40 ppm or less. JP2000-169107 (Jun. 20, 2000) discloses a method for production of hydrogen-containing gas reduced in carbon monoxide, where a catalyst prepared by carrying Ru and an alkali metal and/or an alkaline earth metal on a carrier of titania and alumina in the example can be employed to reduce the concentration of carbon monoxide from 0.6% to 50 ppm or less at a temperature in the range of 60° C. to 160° C. JP05201702 (Aug. 10, 1993) discloses a method and an apparatus for selectively removing carbon monoxide, where the Ru/Al₂O₃ and Rh/Al₂O₃ catalysts can be employed to reduce the concentration of carbon monoxide in the hydrogen-containing gas to 0.01% or less at 120° C. or less. The U.S. patents related to the application of CO preferential oxidation are described above. None of the prior arts teaches the catalyst disclosed by the present invention and the preparation thereof.

### SUMMARY OF THE INVENTION

The object of the present invention is to provide a method for preparation of a manganese oxide-cerium oxide-supported nano-gold catalyst, which can be employed to reduce the concentration of carbon monoxide contained in hydrogen stream in a fuel cell to less than 100 ppm so as to prevent CO from contaminating the electrodes of a fuel cell.

Another object of the present invention is to provide a process for subjecting carbon monoxide and oxygen to interaction resulting in the formation of carbon dioxide in a hydrogen-rich environment by a manganese oxide-cerium oxide-supported nano-gold catalyst. The process can be applied to remove carbon monoxide in a hydrogen tank so as to enhance the purity of hydrogen stream.

Manganese oxide and cerium oxide of the present invention can be mixed in various molar ratios, and the size of the gold particle is not limited. Preferably, the diameter of the gold particle is about less than 5 nm.

The present invention uses a continuous fixed-bed reactor to perform preferential oxidation of carbon monoxide in the presence of carbon monoxide, oxygen, hydrogen, and helium by a manganese oxide-cerium oxide-supported nano-gold catalyst.

The present invention relates to a CO oxidation catalyst used for preferential oxidation of carbon monoxide, comprising a carrier of mixed manganese oxide and cerium oxide, and nano-gold particles supported on the carrier. The size of the nano-gold particle used in the present invention is not limited. Preferably, the diameter of the nano-gold particle is less than 5 nm.

The present invention provides a method for preparation of a carrier-supported nano-gold catalyst, comprising the following steps: (a) mixing a manganous nitrate solution and cerium oxide, and then forming an oxide as a carrier by calcining at a temperature in the range of from 300° C. to 500° C.; (b) mixing a gold-containing solution and the oxide in water to form a precipitate as a nano-gold catalyst; (c) adjusting the pH value of the resulting solution from the step (b) by an alkali solution with continuous stirring in precipitating the nano-gold catalyst; (d) washing the precipitate by distilled water; (e) drying the precipitate; and (f) calcining the dried precipitate at a temperature in the range of 120° C. to 200° C.

In the method for preparing a carrier-supported nano-gold catalyst according to the present invention, the carrier is mixed oxides manganese oxide and cerium oxide prepared by impregnation. The molar ratio of Mn to Ce is not limited. Preferably, the molar ratio of Mn to Fe is in the range of 1/99 to 50/50.

In the method for preparing a carrier-supported nano-gold catalyst according to the present invention, the time for calcining after mixing the manganous nitrate solution and the cerium oxide is not limited. Preferably, the time for calcining is in the range of 2 hours to 6 hours.

In the method for preparing a carrier-supported nano-gold catalyst according to the present invention, the temperature for precipitating the nano-gold catalyst is not limited. Preferably, the temperature maintains in the range of 50° C. to 90° C.

In the method for preparing a carrier-supported nano-gold catalyst according to the present invention, the alkali solution for adjusting the pH value in precipitating the nano-gold catalyst is not limited. Preferably, the alkali solution is an ammonia solution.

In the method for preparing a carrier-supported nano-gold catalyst according to the present invention, the pH value is adjusted to less than 10 in precipitating the nano-gold catalyst. Preferably, the pH value is in the range of 5 to 9.

In the method for preparing a carrier-supported nano-gold catalyst according to the present invention, the time for continuous stirring in precipitating the nano-gold catalyst is not limited. Preferably, the time for continuous stirring is in the range of 1 hour to 10 hours.

In the method for preparing a carrier-supported nano-gold catalyst according to the present invention, the precipitate is washed by distilled water with a temperature lower than 80° C. Preferably, the temperature of the distilled water is in the range of 60° C. to 70° C.

In the method for preparing a carrier-supported nano-gold catalyst according to the present invention, the precipitate is dried at a temperature lower than 95° C. Preferably, the temperature for drying is in the range of 80° C. to 90° C.

In the method for preparing a carrier-supported nano-gold catalyst according to the present invention, the time for drying the precipitate is not limited. Preferably, the time for drying is in the range of 10 hours to 12 hours.

In the method for preparing a carrier-supported nano-gold catalyst according to the present invention, the time for calcining the dried precipitate is not limited. Preferably, the time for calcining is in the range of 2 hours to 10 hours.

The present invention also further provides a method for removing carbon monoxide contained in gas, comprising: performing reaction in hydrogen-containing gas at an operating temperature in the range of 20° C. to 200° C. by a manganese oxide-cerium oxide-supported nano-gold catalyst to oxide carbon monoxide to form carbon dioxide. The hydrogen-containing gas comprises oxygen, carbon monoxide, hydrogen, and helium, and the molar ratio of carbon monoxide to oxygen is in the range of 0.5 to 3.

In the method for removing carbon monoxide in the hydrogen-containing gas by a manganese oxide-cerium oxide-supported nano-gold catalyst according to the present invention, the weight percentage of the gold is not limited. Preferably, the weight percentage of the gold is in the range of 1% to 3%.

In the method for removing carbon monoxide in the hydrogen-containing gas by a manganese oxide-cerium oxide-supported nano-gold catalyst according to the present invention, the molar ratio of carbon monoxide to oxygen in the gas is in the range of 0.5 to 3. Preferably, the molar ratio of carbon monoxide to oxygen is in the range of 1 to 2.

In the method for removing carbon monoxide in the hydrogen-containing gas by a manganese oxide-cerium oxide-supported nano-gold catalyst according to the present invention, the operating temperature is in the range of 20° C. to 200° C. Preferably, the operating temperature is in the range of 25° C. to 100° C.

### BRIEF DESCRIPTION OF THE DRAWINGS

none

### DETAILED DESCRIPTION OF THE PREFERRED EMBODIMENT

### EXAMPLE 1

Mn/Ce mixed oxides (8 g) as a carrier supporting gold are prepared by impregnation, and the process thereof is described as the following Steps 1 and 2. Subsequently, gold is supported on the aforementioned carrier by deposition-precipitation, and the detailed process is described as the following Steps 3 to 8, so as to provide a catalyst of w % Au/MnO₂/CeO₂ (Mn/Ce=x/10−x), wherein w is 1, and x is 1.

(Step 1) For preparation of an oxide carrier (molar ratio of Mn to Ce is 1/9), 1.12 g of Mn(NO₃)₂.4H₂O (molecular weight 251, commercially available in Aldrich) is taken, and dissolved in 3 mL of distilled water.

(Step 2) The aqueous solution prepared in Step 1 is gradually dropped into 6.88 g of CeO₂ (molecular weight 172, commercially available in Degussa) with stirring, followed by calcining for 4 hours at 400° C. in air, so as to obtain gray MnO₂/CeO₂ powder, and then the powder is ground.

(Step 3) The powder (2.475 g) prepared in Step 2 is added into 150 mL of distilled water, and the solution is magnetically stirred and heated to 65° C.

(Step 4) Tetrachloroauric acid (0.048 g, commercially available in Strem Chemicals) is taken and dissolved in 50 mL of distilled water (the content of gold is 0.025 g).

(Step 5) The pH value of the solution prepared in Step 3 is adjusted to 8±10.2 by addition of 0.1M ammonia solution, followed by the addition of the tetrachloroauric acid solution at 10 mL/min, and simultaneously, the pH value is adjusted to 8±0.2, and the temperature is maintained at 65° C.

(Step 6) The resulting solution prepared in Step 5 is magnetically stirred for 2 hours, and simultaneously, the pH value is adjusted to 8.5±0.2, and the temperature is maintained at 65° C. to accomplish reaction.

(Step 7) The resulting precipitate is filtered out and washed by 70° C. distilled water several times to thoroughly remove chloride ion, followed by drying for 12 hours at 80° C.

(Step 8) The dried catalyst is calcined in air for 4 hours at 180° C. to afford dark purple 1% Au/MnO₂—CeO₂ powder (molar ratio of Mn to Ce is 1/9).

### EXAMPLE 2

The process is similar to that described in Example 1, except that the molar ratio of Mn to Ce is 5/5 and 4.75 g of Mn(NO₃)₂.4H₂O (molecular weight 251, commercially available in Aldrich) is taken in Step 1, and 3.25 g of CeO₂ (molecular weight 80, commercially available in Degussa) is taken in Step 2.

### EXAMPLE 3

The process is similar to that described in Example 1, except that the dried catalyst is calcined in air for 4 hours at 120° C. in Step 8.

### EXAMPLE 4

The process is similar to that described in Example 2, except that the dried catalyst is calcined in air for 4 hours at 120° C.n in Step 8.

### EXAMPLE 5

The process is similar to that described in Example 4, except that the total stream of inlet gas consists of CO, O₂, H₂, and He in volume ratio of 1/1.5/49/48.5.

The catalyst of 1 wt. % Au/MnO₂/CeO₂ (about 0.1 g) prepared in each aforementioned example is taken and disposed in a vertical fixed-bed reactor to perform preferential oxidation of carbon monoxide in a hydrogen-rich environment. The space between the inner and outer walls of the reaction tube in the vertical fixed-bed reactor is packed with molten silica sand to hold reactive catalyst, whereby gas can pass through the space packed with the molten silica sand. In addition, the bottom of the glass reaction tube is sealed to dispose a thermocouple thermometer therein for testing the temperature of the catalyst surface.

The total stream of inlet gas consisting of CO, O₂, H₂, and He in volume ratio of 1.33/2.66/64.01/32 is adjusted to 50 mL/min by a mass flow rate controller and introduced into the reactor at room temperature. The product from the reaction gas is analyzed by Gas Chromatography (China 9800) using a stainless steel column (length 3.5 m) packed with molecular sieves 5A.

The temperature of the reactor is controlled by a cylindrical couple heater, and glass fibers (length 4 cm) are spread in the heater to function as a heat-retention element. The temperature of the reactor rises from room temperature at 2° C.min. The temperature is kept at 25° C., 50° C., and 80° C. for 10 minutes, respectively, and the analysis is carried out at the 5^{th} minute, as the following table 1.

The test results of all examples are shown in the following table 1, where CO conversion ratio and CO selection ratio are defined as the following:

CO conversion ratio=(input CO concentration−output CO concentration)/input CO concentration;

CO selection ratio=consumption of O₂ for CO oxidation/(consumption of O₂ for CO oxidation+consumption of H₂ for CO oxidation).

All examples show that CO conversion is 100% and output CO concentration is less than 50 ppm. It is proven that the catalyst of the present invention can efficiently remove CO in gas, and can be further applied in removing CO in a fuel cell to prevent CO from contaminating the electrodes of the fuel cell. In addition, the catalyst of the present invention can be employed to reduce the concentration of CO in H₂ stream of the fuel cell to less than 100 ppm so as to prevent CO from contaminating the electrodes of the fuel cell, and also can be applied in removing CO in a hydrogen tank to enhance the purity of the hydrogen stream.

TABLE 1
Test Results of Examples

| | Synthesis Condition of Carrier | | | | CO | CO |
|---|---|---|---|---|---|---|
| | | Tem- | | | Selec- | Con- |
| | Gold | perature | | Temperature | tion | version |
| Exam- | Content | for | | for Reaction | Ratio | Ratio |
| ple | (%) | Calcining | Mn/Ce | (° C.) | (%) | (%) |
| 1 | 1 | 180 | 1/9 | 25 | 73.5 | 100 |
| 1 | 1 | 180 | 1/9 | 50 | 47.7 | 100 |
| 1 | 1 | 180 | 1/9 | 80 | 42.4 | 100 |
| 2 | 1 | 180 | 5/5 | 25 | 74.1 | 100 |
| 2 | 1 | 180 | 5/5 | 50 | 57.9 | 100 |
| 2 | 1 | 180 | 5/5 | 80 | 47.1 | 100 |
| 3 | 1 | 120 | 1/9 | 25 | 81.1 | 100 |
| 3 | 1 | 120 | 1/9 | 50 | 52.3 | 100 |
| 3 | 1 | 120 | 1/9 | 80 | 49.2 | 100 |
| 4 | 1 | 120 | 5/5 | 25 | 61 | 100 |
| 4 | 1 | 120 | 5/5 | 50 | 51.5 | 100 |
| 4 | 1 | 120 | 5/5 | 80 | 49.3 | 100 |
| 5 | 1 | 120 | 5/5 | 25 | — | 100 |
| 5 | 1 | 120 | 5/5 | 50 | — | 100 |
| 5 | 1 | 120 | 5/5 | 80 | — | 100 |

Although the present invention has been explained in relation to its preferred embodiment, it is to be understood that many other possible modifications and variations can be made without departing from the spirit and scope of the invention as hereinafter claimed.

What is claimed is:

1. A carbon monoxide oxidation catalyst used for preferential oxidation of carbon monoxide in a hydrogen-rich environment, comprising: a carrier of mixed manganese oxide and cerium oxide; and nano-gold particles supported on the carrier.

2. The carbon monoxide oxidation catalyst as claimed in claim 1, wherein the diameter of the nano-gold particle is less than 5 nm.

3. A method for preparation of a carrier-supported nano-gold catalyst, comprising:
(a) mixing a manganous nitrate solution and cerium oxide, and then forming an oxide as a carrier by calcining at a temperature in the range of 300° C. to 500° C.;
(b) mixing a gold-containing solution and the oxide in water to form a precipitate as a nano-gold catalyst;
(c) adjusting the pH value of the resulting solution from the step (b) by an alkali solution with continuous stirring in precipitating the nano-gold catalyst;
(d) washing the precipitate by distilled water;
(e) drying the precipitate; and
(f) calcining the dried precipitate at a temperature in the range of from 120° C. to 200° C.

4. The method as claimed in claim 3, wherein the carrier is mixed oxides MnO₂ and CeO₂ prepared by impregnation, and the molar ratio of Mn to Ce is in the range of 1/99 to 50/50.

5. The method as claimed in claim 3, wherein the time for calcining in the step (a) is in the range of 2 hours to 6 hours.

6. The method as claimed in claim 3, wherein the temperature for precipitating the nano-gold catalyst in the step (b) maintains in the range of 50° C. to 90° C.

7. The method as claimed in claim 3, wherein the alkali solution for adjusting the pH value in precipitating the nano-gold catalyst in the step (c) is an ammonia solution.

8. The method as claimed in claim 3, wherein the pH value in precipitating the nano-gold catalyst in the step (c) is in the range of 5 to 9.

9. The method as claimed in claim 3, wherein the time for continuous stirring in precipitating the nano-gold catalyst in the step (c) is in the range of 1 hour to 10 hours.

10. The method as claimed in claim 3, wherein the temperature of the distilled water in the step (d) is in the range of 60° C. to 70° C.

11. The method as claimed in claim 3, wherein the temperature for drying in the step (e) is in the range of 80° C. to 90° C.

12. The method as claimed in claim 3, wherein the time for drying in the step (e) is in the range 10 hours to 12 hours.

13. The method as claimed in claim 3, wherein the time for calcining the dried precipitate in the step (f) is in the range of 2 hours to 10 hours.

14. A method for removing carbon monoxide contained in gas, comprising: performing reaction in hydrogen-containing gas at an operating temperature in the range of 20° C. to 200° C. by a manganese oxide-cerium oxide-supported nano-gold catalyst, wherein the hydrogen-containing gas comprises oxygen, carbon monoxide, hydrogen, and helium, and the molar ratio of the carbon monoxide to the oxygen is in the range of 0.5 to 3.

15. The method as claimed in claim 14, wherein the weight percentage of the gold contained in the manganese oxide-cerium oxide-supported nano-gold catalyst is in the range of 1% to 3%.

16. The method as claimed in claim 14, wherein the molar ratio of the carbon monoxide to the oxygen is in the range of 1 to 2.

17. The method as claimed in claim 14, wherein the operating temperature is in the range of 25° C. to 100° C.
